(19) United States
(12) Patent Application Publication
(10) Pub. No.: US 2021/0247221 A1
(43) Pub. Date: Aug. 12, 2021

(54) REAL-TIME WATER FLOW METER

(71) Applicant: Maxwell Danlogo, West Valley City, UT (US)

(72) Inventor: Maxwell Danlogo, West Valley City, UT (US)

(21) Appl. No.: 17/180,937

(22) Filed: Feb. 22, 2021

Related U.S. Application Data
(63) Continuation-in-part of application No. 15/398,994, filed on Jan. 5, 2017, now abandoned.

(51) Int. Cl. G01F 15/18; G01F 15/06; G01D 4/00; G01D 4/02

(52) U.S. Cl. CPC G01F 15/185; G01F 15/063; G01D 2204/43; G01D 4/02; G01D 4/004

(57) ABSTRACT

A real-time water flow meter that includes: a flow tube, wherein the flow tube is adapted to connect in line with a water pipe; a water flow detector wherein the water flow detector translates water flow through the flow tube into desirable units of measurement; and a threaded connector at each end of the flow tube in order to connect the flow tube into the water line of a user. The water flow meter further includes a rechargeable battery and a battery indicator with an alarm, as well as a mini generator. Other aspects of the water flow meter include memory compartment in the form of an SD card slot and wireless network connectivity.

### CROSS REFERENCE TO OTHER APPLICATIONS

This application claims priority to U.S. patent application Ser. No. 15/398,994 filed on Jan. 5, 2017.

### BACKGROUND OF THE INVENTION

### Field of Invention

The present invention relates to a commercial or residential real time water flow meter.

### Description of Related Art

Individuals especially homeowners must typically incur water bills and therefore monitor water usage. Although some devices have been developed for this purpose many are not effective enough to provide a complete record in real time to the consumer. It can be imperative for consumers to maintain a real-time measure of water usage in order to control costs. Further in some areas of the country water usage is at a premium and therefore it is imperative for water conservation that users maintain accurate data related to water usage. As a result, an effective water flow meter providing real time data may be an asset to the existing art.

### SUMMARY OF THE INVENTION

The present invention relates to a water flow meter that includes: a high pressured water resistant flow tube, wherein the flow tube is adapted to connect next to the shut off valve of the main water pipe line; a water flow detector wherein the water flow detector translates water flow through the flow tube into a volume of water; and a threaded connector at each end of the flow tube in order to connect the flow tube into the main water line of a user. The water flow meter further includes a rechargeable battery and a battery indicator comprising of an alarm and a red, yellow, and green flashing lights. Other aspects of the water flow meter include a water proof battery compartment, a mini generator that connects directly to the battery, a memory chip compartment in the form of an SD card slot, wireless network connectivity, a programmable circuit board, and a cell phone software application.

The present invention provides a means for users to cut back on monthly water usage by providing detailed representation of their water utilization within thirty seconds after water usage. Users can also set a limit on the water volume they desire to use on a monthly basis. Preferably the users may set an alert on the designated cell phone application for the device, to prompt them that they are nearing a preset set limit so they can adjust usage accordingly. If users decide not to set a limit on water volume to use per month, then the accumulative real time updates enable users know if they are spending too much on water so they adjust water usage and ultimately save money and conserve water.

There are a lot of water flow meters out there including the common water meters used by municipalities to calculate water usage for each household, but none of them can give the data to users in real time. Further, each municipality will usually have a predetermined cost amount per unit that is used to calculate water usage by individual residents. Users will be able to manually enter the cost per unit during the installation of the device and update this information every time changes are made by the municipality, therefore the present invention may be used anywhere in the world.

### BRIEF DESCRIPTION OF DRAWINGS

FIG. 1 depicts a water flow meter in accordance with the present invention.

FIG. 2 depicts cross-sectional views of the water flow meter in accordance with the present invention.

FIG. 3 depicts a front view of the water flow meter in accordance with the present invention.

FIG. 4 depicts a diagram showing steps related to the use the water flow meter in accordance with the present invention.

### DETAILED DESCRIPTION

The present invention relates to a water flow meter that connects next to the shut off valve of the main pipe line within a residence. The water flow meter includes a flow detector that translates water flow into desired units of measurement for storage in a memory unit. Software residing within the flow detector interprets the raw data from the detector into readable values. Further aspects of the water flow meter include a rechargeable battery that supplies power for the components of the water meter. Further wireless network connectivity is provided on the water meter to transmit data to a cell phone, a tablet computer, or a desk top computer. Other features of the water flow meter include a rechargeable battery and a mini generator that automatically charges the battery as water passes through the flow meter. A battery indicator with an alarm is also shown indicating the status of the battery during use. A green light of the battery indicator is on when the battery is fully charged, a yellow light comes on when the battery has fifty percent charge in it, and a red light accompanied by a high beeping alarm when the battery is less than ten percent charged, or is unable to hold a charge. In the event that the battery is unable to hold a charge the user can replace the rechargeable battery with a nine-volt battery, while waiting to get a replaceable rechargeable battery. Further, the water flow meter includes a waterproof battery compartment to prevent any possibility of electrical short circuiting, which will help prolong the life of the flow meter. The memory compartment comprises of an SD card slot wherein the user inserts an SD card to keep record of all data generated by the flow meter. A programmable circuit board with a processor is also included in the flow meter to help with the installation of the various electronic components, and allow for the development and installation of a computer software in the flow meter, to help generate the desired results, and sync those results to the users cell phone or computer. The designated cell phone application interacts with users flow meters software through the internet to retrieve saved data in the SD card, and interprets it with its programmed algorithm into billable amount of money used on water so far. The water flow meter may also include a screen that provides an image of data related to water flow. In the event that a user's device is unable to sync data with the cell phone application, the user can manually retrieve this data from the screen. The present invention further includes a barcode on each water meter so that users can scan to sync their devices with the cell phone application during installation. Only one barcode is allocated for each device. Each barcode has a unique identifier in the form of a serial number which ensures only the respective users connect to flow meter. This ensures security of users devices and decrease the risk of hackers gaining access to their flow meter, and distorting their data.

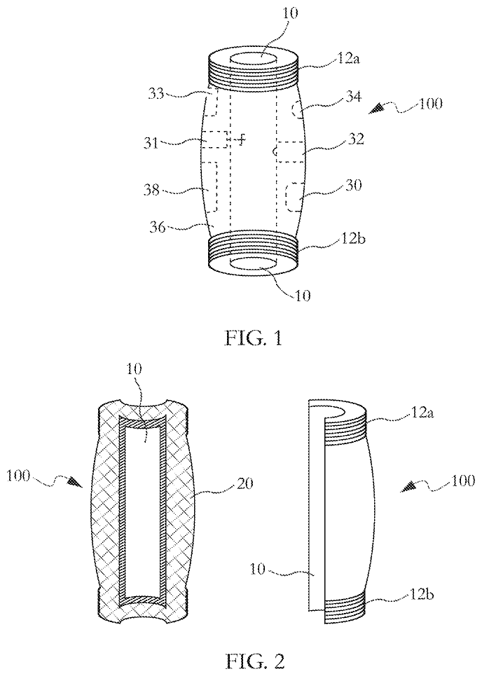

In reference to FIG. 1, a water flow meter 100 in accordance with the present invention is depicted. The water flow meter 100 includes a high pressured water resistant flow tube 10 with connecting threads at each end of the flow tube 10. Connecting threads 12a, 12b are shown in FIG. 1. The high pressured water resistant flow tube 10 allows for adequate amounts of water to go through the flow meter without causing any distress or damage to the housing of the flow meter. Threads 12a, 12b allow for the connection of the flow meter 100 in the main water supply pipe of a residence. FIG. 2 provides cross-sectional view of the flow meter 100 in accordance with the present invention, where the interior of flow tube 10 is shown.

Other components of the flow meter 100 include water detector 32 and a rechargeable battery 38 with an alarm battery indicator 36. The battery 38 supplies power to the water flow detector and other components of the flow meter 100. A mini generator 31 is also shown. The generator 31 provides a means to automatically recharge the battery 38 and is operated via the flow of water through flow tube 10. Further the flow meter 100 includes an SD card slot 33. This allows users to insert an SD card memory chip to store data related to water flow through the flow tube 10. One additional aspect of the flow meter 100 is the ability to transfer data through wireless internet connection provided by a transmitter 30. Transmitter 30 transmits data to a computer, tablet, or smartphone of the user in order to provide detailed comparative near accurate data about users' water utilization. It is considered near accurate because the flow meter is able to record ninety-nine percent of water utilization. The user will have to factor in the difference from the connection of the city's flow meter, to the point of connection of the flow meter into his/her main water supply pipeline to achieve a perfect representation of water flow into his/her residence. Users can easily achieve this by adding the difference from their utility bill to the monetary billable data generated from the flow meter. The idea of the rechargeable battery in the device is to allow it to work with or without electricity. In the event that there is a power outage the data storage component of the flowmeter 100 (SD card) is able to store this data and sync it to a user's electronic device, once power and internet services are restored in the user's home.

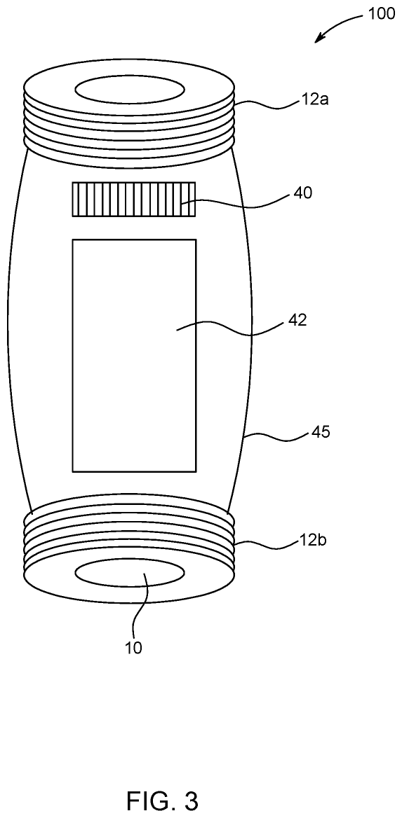

FIG. 3 shows a front view of the flow meter 100. Each flow meter 100 includes a barcode 40 and an interactive touch screen 42. The barcode 40 provides a unique identifier (serial number) for each flow meter 100. The interactive touch screen 42 enables a user to gather data from the flow meter concerning water usage, when it's unable to sync the data with user's cell phone application. Further the flow meter 100 is encased within a brass housing 45 to ensure durability.

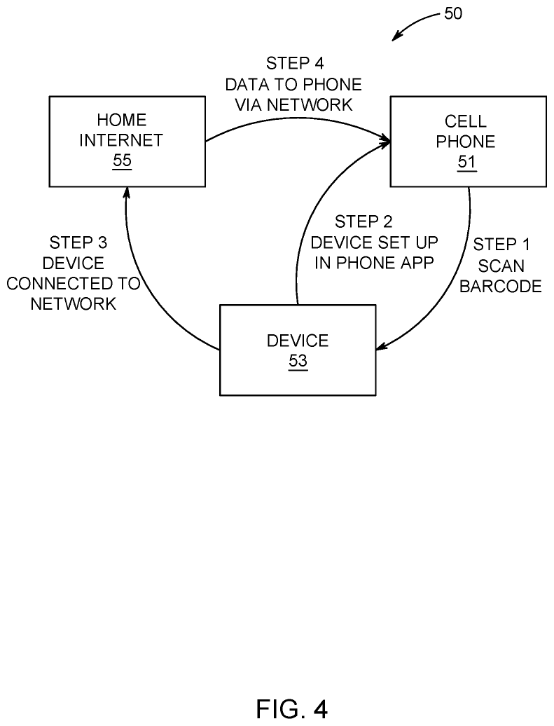

FIG. 4 provides a flow diagram depicting steps related to the usage of the flow meter 100. Initially a user scans a barcode using a smart phone application 51 and, the water meter (device) 53 is set up on the specified application that comes with the barcode scanning function. Data related to device 53 is sent to the smartphone 51 via a network 55, where data may then be viewed and analyzed.

The present invention as described above provides real time data as water passes through the flowmeter 100. The unique part of the flowmeter system relates to its ability to convert the raw data using an inbuilt calculator, and algorithm in the application into the amount of money the user will be paying in real time. The application converts the water volume to billable fees associated with the water usage. This data is stored and updated each time water runs through the flowmeter 100. The present invention gives the user substantially accurate data related to the next billing cycle for the water bill.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A water flow measurement system comprising:
a water resistant flow tube, wherein the flow tube is adapted to connect in line with a water pipe;
a water flow detector wherein the water flow detector translates and converts water flow into units of measurement;
a threaded connector at each end of the flow tube in order to connect the flow tube into the main water line of a user;
memory compartment in the form of an SD card slot;
a wireless connection between the flow tube and a network, wherein the wireless connection transmits data from the water flow detector;
a user electronic device connected to the network, wherein the user electronic device receives the data and performs analysis of the data through a software application stored on the user electronic device.

2. The water flow measurement system according to claim 1, wherein the flow tube includes a rechargeable battery and a battery indicator with an alarm.

3. The water flow measurement system according to claim 1 further including an inbuilt mini generator.

4. The water flow measurement system according to claim 1 further including wireless network connectivity.

5. The water flow measurement system according to claim 1, where the flow tube includes a unique barcode identifier.

6. The water flow meter according to claim 1, where the flow tube further includes an interactive screen.

7. The water flow measurement system according to claim 1, where water flow data is automatically converted into cost data on water utilization within thirty seconds after water is usage

8. A water flow measurement system according to claim 1, where the flow tube automatically transmit data in real time to a user's electronic device.

9. The water flow measuring system according to claim 1, where an inbuilt computer software automatically converts raw water flow data into desirable units of measurement for liquids, stores the converted data in an SD card, and automatically syncs that data to at least one user's electronic device.

10. The water flow measurement system according to claim 1, where the user electronic device includes a software application that enables a barcode scanner, wherein said barcode scanner automatically installs and setups a user's electronic device when the barcode is scanned, and automatically converts synced data into monetary value.
